(19) United States
(12) Patent Application Publication
(10) Pub. No.: US 2014/0193786 A1
(43) Pub. Date: Jul. 10, 2014

(54) KEYBOARD TRAINING SYSTEM AND METHOD

(71) Applicant: LATKEY LTD., CO DUBLIN (GB)

(72) Inventor: DENIS IVANOV, CO DUBLIN (IE)

(73) Assignee: LATKEY LTD., CO DUBLIN (GB)

(21) Appl. No.: 14/145,036

(22) Filed: Dec. 31, 2013

(30) Foreign Application Priority Data
Jan. 9, 2013 (IE) GB 1300340.5

(51) Int. Cl. G09B 13/00

(52) U.S. Cl. CPC G09B 13/00
USPC 434/227

(57) ABSTRACT

A computer console comprising a display, one or more speakers, a computer and a keyboard has key top stickers each applied each to a respective keyboard character key. Each respective key top sticker provides a cartoon image of an animal drawn in the shape of the underlying letter represented by the respective character key. The key top stickers are provided on a character key sheet respectively laid out to correspond with their position to be attached on the keyboard. A writing tablet can also be used by a student to provide a representation of a character to the computer. The computer employs an application program to provide audiovisual shows through the display and speakers indicative of a creature from the key top stickers indicating a character key to be pressed. The application program monitors the character keys pressed by the student and adjusts the audiovisual show in response.

### CROSS-REFERENCE TO RELATED APPLICATION

This application claims priority to foreign application No. GB 1300340.5 filed on Jan. 9, 2013 having the same named inventor.

### FIELD OF THE INVENTION

The present invention relates to a method and system whereby children and young persons may learn the shapes and sounds of letters. The invention particularly relates to such learning involving a keyboard.

### BACKGROUND TO THE INVENTION

One part of the present invention relates to changing or modifying the identifiable characteristics of keyboard keys. This has been suggested, for keyboard training and learning purposes, in several patent applications.

United States patent application US2002051957 (A1) discloses a teaching apparatus and method for enabling a child who does not have a complete mastery of a relationship between upper and lower letters to enter data into a computer. In one embodiment, a computer keyboard overlay having lower-case letters is provided. The overlay is preferably transparent, and the lower-case letter is positioned in a non-interfering location relative to the upper-case letter on the alphabet keys such that both the upper-case and lower-case letters are visible to the child when installed. A computer keyboard is also presented that included both glyphs for upper-case and lower-case letters on the alphabet keys. The glyphs of the lower-case letters may be positioned on the keys directly, or may be applied along with a layer to the keys. This patent application also discloses a method comprising the step of providing a data entry device that displays both upper and lower case letters in association with one another. This method and apparatus has the limitation of not providing training exercises for students. The present invention seeks to provide improvement over this patent application by engaging with students who do not even necessarily know the identity and meanings of individual letters. The present invention also seeks to provide improvement there over by engaging and training students in an entertaining manner appropriate to their age.

United States patents application US2001031167 (A1) discloses a computer keyboard enhancement kit consisting of detachable key replacements made to be larger and to have more shapes and colors than the letter keys of a standard computer keyboard so as to lessen the level of difficulty for children of preschool ages in locating such keys on the keyboard as they work on educational programs. Each of these key replacements takes a specific shape and color, and displays a specific letter that is on the keyboard in either uppercase or lowercase form. The shapes and colors follow a specific pattern scheme wherein the letters of the same hand and row keys have key replacements with the same color but with varied shapes. To be in use, these key replacements are attached to the top surface of a transparent plastic jacket that goes with the kit, and are positioned on top of their corresponding letter keys on the computer keyboard. The simple replacement of keys is insufficient for junior or preschool student training. The present invention seeks to improve over the disclosure of US2002051957 (A1) by providing key covers suitable for engaging the interest of such students and by providing features of the apparatus connected with the keyboard to train such students in a manner suitable for their age.

United Kingdom patent application GB2336570 (A) discloses a keyboard overlay that includes finger touch zones marked with indicia different to the indicium symbol on the underlying keyboard key or pad. The indicium carried by the touch zones may be colour coded or comprise lower case lettering corresponding to the underlying upper case lettering of the keyboard. Each touch zone may be marked with two characters. The overlay may comprise a plurality of layers with the touch zones on each layer marked with indicia different to the indicium on the underlying keyboard. The overlay may include a displaceable cover portion which can be displaced from a cover position, in which access to certain keys is permitted, to a displaced position, in which access to the keys is permitted. The present invention seeks to improve over GB2336570 (A) by training students to use keyboard keys with their proper indicated value rather than with keyboard keys that bear indicia other than their generally allotted value.

None of the above patent applications utilises keyboard associated equipment in actual training of the keyboard user. Further, the student in each of the three patent applications mentioned above is able only to provide input using the keyboard. The present invention seeks to improve over all three patent applications mentioned above by overcoming these limitations.

### SUMMARY OF THE INVENTION

According to a first aspect, the present invention consists in a system for keyboard training, comprising:
a keyboard comprising character keys, each character key representing a letter to be typed;
a processor operable to receive typed characters typed upon the character keys of the keyboard;
a display screen operable to display images provided by the processor;
one or more speakers operable to produce sounds provided by the processor;
where
character keys stickers bearing creature representations are placed upon each of their respective character keys;
where
the processor is operable to select a letter and to provide an audiovisual show through the display screen and/or the speakers to indicate to a student the character key that the students should press.

According to a second aspect, the present invention consists in a method for keyboard training, comprising:
a step of a processor receiving typed characters typed upon the character keys of a keyboard, each character key representing a letter to be typed;
a step of displaying upon a display screen images provided by the processor;
a step of producing sounds provided by the processor on one or more speakers;
a step of attaching character keys stickers bearing creature representations upon each of their respective character keys;
and
a step of the processor selecting a letter and providing an audiovisual show through the display screen and/or the speakers to indicate to a student the character key that the students should press.

The invention further provides that the audiovisual show can include at least one of: animal sounds; static animal images; static animal cartoon images; animal video clips; animal cartoon clips; the sounds of the letter to be pressed; the name of the letter; a representation of the letter to be pressed; and a written image of the letter produced by the character key to be pressed.

The invention further provides that the creature representation for each respective character key is in the form of the shape of the letter represented by that character key.

The invention further provides that the processor can be operable to determine whether or not a key pressed by the student corresponds to the creature represented by the audiovisual show; and wherein the processor is further operable to tailor the audiovisual show in response to the keyboard activity of the student.

The invention further provides for the provision a writing tablet that can be operable to provide representation of a character written thereon to the processor; and that the processor can be operable to determine whether or not the written character from the writing tablet corresponds to the character represented by the audiovisual show.

The invention further provides that the creature representations can be cartoon representations.

The invention further provides that the character keys stickers can be provided on a character key sheet and laid out to correspond to the positions on the keyboard whereto they are to be attached.

### BRIEF DESCRIPTION OF THE DRAWINGS

The invention is explained, by way example, by the following description to be read in conjunction with the appended drawings, in which:

FIG. 1 shows an exemplary apparatus suitable for use to implement the present invention.

FIG. 2 shows a character key top stickers sheet provided to a user to be stuck on the character keys.

FIGS. 3A and 3B, show examples of possible cartoon representations of animals that can be used as the illustration on individual character key stickers.

FIG. 4 shows how a character key sticker is attached to its corresponding character key.

FIG. 5 shows a schematic block diagram of the contents of the processor of the personal computer (or other computing device) shown in FIG. 1.

FIG. 6 shows an alternative arrangement of interconnections permitting the invention to be practised differing from the arrangement shown in FIG. 1.

and

FIG. 7 is an exemplary flow chart showing one way in which the application program can interact with a student.

### DETAILED DESCRIPTION

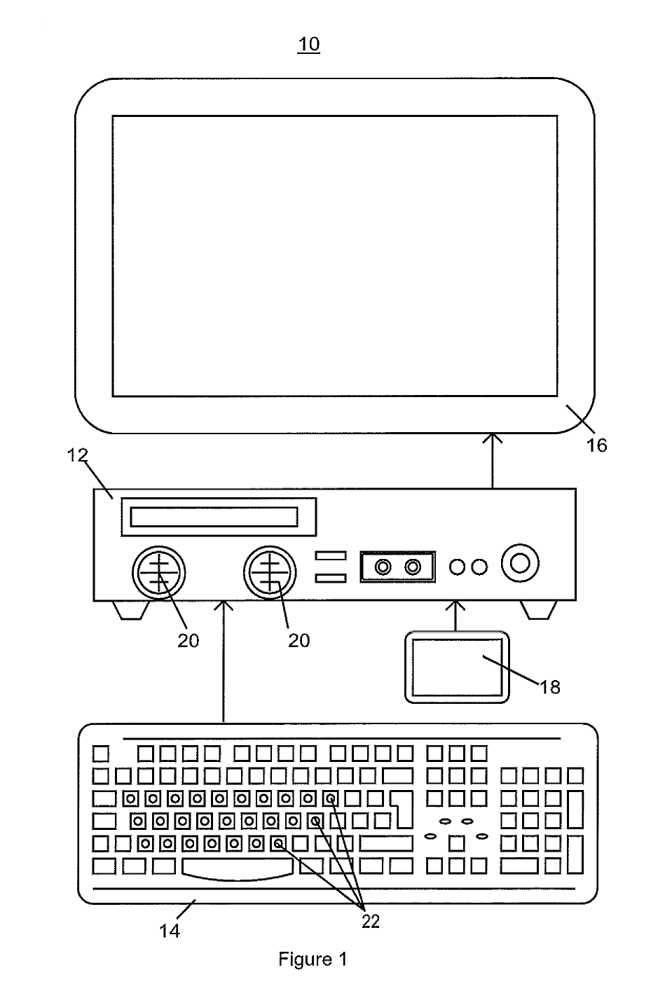

Attention is first drawn to FIG. 1, a partially schematic view of one type of apparatus suitable for use to implement the present invention.

A computer console 10 comprises, for example, a personal computer (PC) 12 provided with keystroke input by a keyboard 14 and driving a display 16. The personal computer 12 can also be provided with input by a writing tablet 18 whereon a person can move their fingertip or a stylus to leave a trail capable of interpretation by the personal computer 12.

The personal computer 12 also comprises one or more speakers 20. As will be described hereafter, the personal computer 12 can, under the control of operating software, cause sounds to be emitted by the speakers 20 for interpretation by a student during training.

The keyboard 14 can be one of many different styles. The keyboard generally comprises more than one hundred keys, only twenty-six of which designate a letter to be typed. The remaining keys are employed to cause typing of other characters, evoking of functions and mode selection. In FIG. 1 the character keys 22 that are employed to cause a selected character to be typed are designated and distinguished, by way of clarification, by a circle within the area of each character key 22.

The keyboard 14 shown in FIG. 1 is of a standard English language layout. The examples given here below relate to an English-language keyboard. However, it is to be appreciated that the invention also extends to keyboards of different layout, having a different number of character keys and having different characters. The layout and the number of character keys will vary between languages. As one small example, the layout of a French keyboard differs from that of an English-language keyboard. In other languages, such as Russian or Bulgarian, the Cyrillic alphabet is used instead of the Roman alphabet. Arabic keyboards are different again. The invention encompasses all of these variations.

The computer console 10 shown in FIG. 1 is just one of many different arrangements upon which the present invention can be practised. Suitable apparatus includes, but is not limited to: laptop computers; notebook computers; games consoles; and interactive televisions. The present invention can be practised upon any combination of apparatus that allows a keyboard and/or a writing tablet 18 to provide input in response to images provided and sounds emitted.

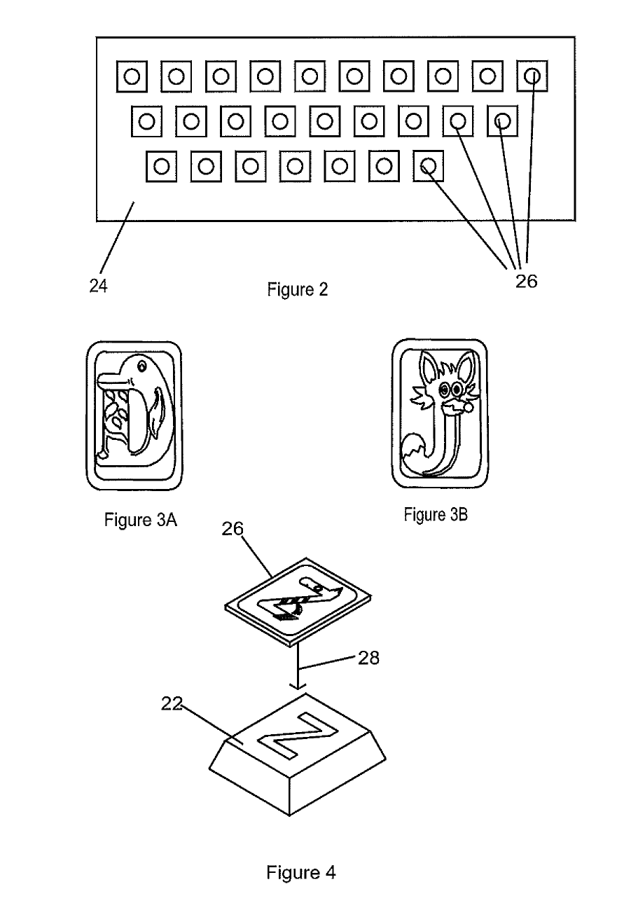

Attention is next drawn to FIG. 2 which shows shows a character key top stickers sheet provided to a user to be stuck on the character keys.

It is known to use an adhesive key-top stickers to replace the characters on keys that have become worn away, or to change the characters provided on each key. A similar arrangement is provided in the present invention, but only for character keys 22 and the not too provide an exact replacement for underlying key characters.

A character key sticker sheet 24 has character key stickers 26 removably attached thereto. The character key stickers 26 each have a cartoon representation of an animal whose name starts with a letter from the set A-Z. The cartoon representation is provided in the shape of the name-start letter of the animal. There are 26 different key stickers 20 each with its own representative cartoon animal. For preference, the key stickers 26 are laid out in the same order in which they occur on the keyboard 14. The key stickers 26 preferably comprise an adhesive backing by which they can be attached to the key sticker sheet 24 and to their individual keys 22 when they are detached from the key sticker sheet 24.

Attention is next drawn to FIGS. 3A and 3B, showing examples of possible cartoon representations of animals that can be used as the illustration on individual character key stickers 26. FIG. 3A shows an exemplary cartoon creature whose name begins with the letter D, a dolphin. In the recitation of the alphabet, it might represent “D is for the dolphin”. FIG. 3B shows an exemplary cartoon character whose name begins with the letter J, a jackal. In the recitation of the alphabet, it might be represented as “J is for jackal”. Depending upon local cultural norms, the animals represented in the cartoons may differ. The animal represented never repeats within the set of twenty-six character key stickers 26. It is to be appreciated that although cartoon representations of animals are preferred because of the age of the students and the need to keep their attention, other representations such as photographs may also be used.

Attention is next drawn to FIG. 4, showing how a character key sticker 26 is attached to its corresponding character key 22.

A character key sticker 26 is detached from the character key sticker sheet 24 and applied to the top of the corresponding character key 22 to remain attached thereon. In the example shown in FIG. 4, the cartoon character represents “Z for zebra” and is attached to the “Z” character key as indicated by arrow 28.

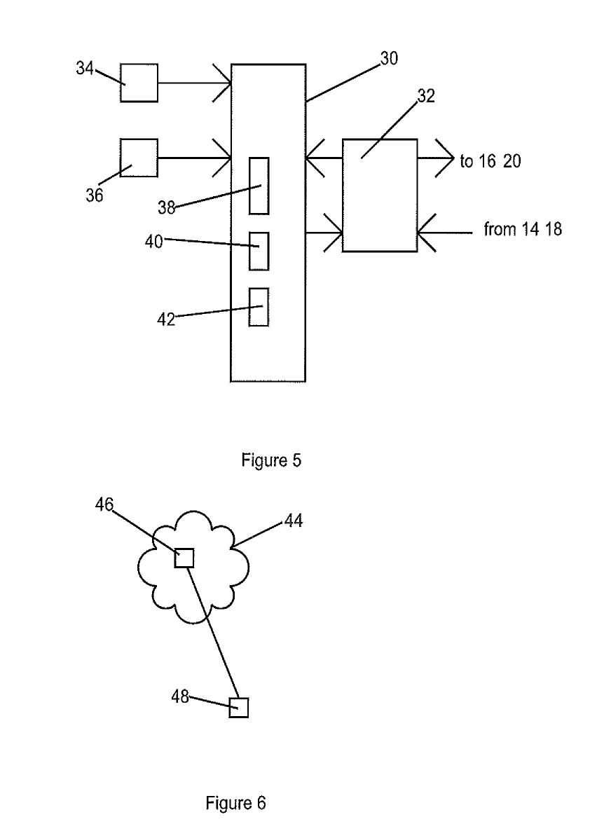

Attention is next drawn to FIG. 5 showing a schematic block diagram of the application program content of the processor of the personal computer (or other computing device) shown in FIG. 1.

An application program 30, comprises an interface portion 32 that is operable to provide video input to the display 16, audio input to the speakers 20, and to receive output from the keyboard 14 and the writing tablet 18.

Video file resources 34 and audio file resources 36 can be called up by the application program 30 provide input to the console 10 and thus to the student.

Also included within the application program 30 is a selection portion 38 that operates, for example, pseudo-randomly to select the alphabetic character to be presented to the student and also the type of input to be provided with that presentation. These selection portion, within the invention, can also operate according to any other algorithm of which the skilled person is aware.

The application program 30 also includes a modification portion 40 that inspects the responses given by the student and varies the presentation given to the student dependently upon the degree of achievement of that student.

The application program 30 also includes a character recognition portion 42 that runs a character recognition algorithm upon input received from the writing tablet 18, decides what character it represents, and provides indication of the represented character to the main program in the application program 30.

The elements shown 32 34 36 38 40 42 within the application program 3Q are by no means exhaustive and further elements that may be required will become apparent from the following detailed description.

Before running the application program 30, the user applies each key top sticker 26 to its respective character key 20. The cartoon representation of animals in the form of the underlying character key 20 letter, provides a significant advantage for non-student keyboard users.

A significant proportion of keyboard users are not touch typists. They rely upon visual cues to locate a typing digit over a selected keyboard key before it is depressed. Because the cartoon representation of an animal is provided in the same shape as the letter of the key to which it is attached, the visually-locating keyboard user can readily find the key that they desire to press.

Attention is next drawn to FIG. 6, showing an alternative arrangement of interconnections permitting the invention to be practised and different from the arrangement shown in FIG. 1. The arrangement shown in FIG. 6 is suitable for the growing number of machines that do not actually contain application program 30, but rather use an “App”, where an “App” is a small graphic interface whereby communication is established and made with a device that supports the application program 30.

A network 44, which is preferably the Internet but could be any other communication network, comprises a network server 46 that allows two-way communication to be established with a client machine 48 that also comprises a keyboard, tablet (optional), a sound producing device and a display. The network server 46 contains the application program 30 in much the same way as the personal computer 12 of FIG. 1. The “App” allows student input at the client machine 48 to be transferred as input to the network server 46, and also allows responses from the application program 30 in the network server to become sounds and images at the client machine 48.

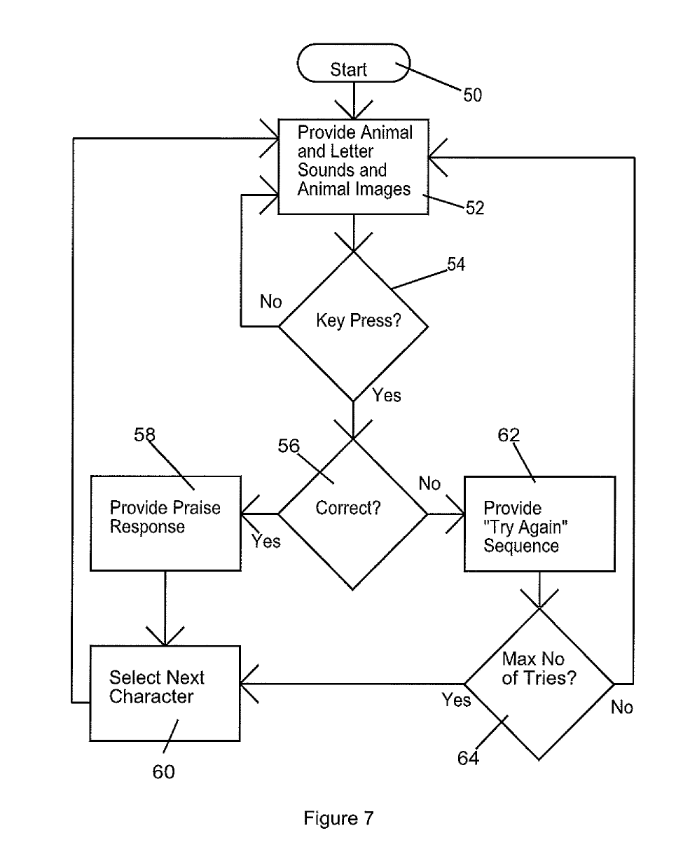

Attention is next drawn to FIG. 7, a flow chart showing a first manner in which the application program 30 can interact with a student.

From a start 58 a first operation 52 causes the speakers 20 to provide sounds made by or associated with the animal on the key top sticker 26 that is attached to the desired character key 22. The first operation 52 also causes the speakers 22 provide to the student the sounds of the desired letter. The application program 30, as well as providing sounds, in the first operation 52 also causes the display 16 to provide images of the animal on the key top sticker 26 of the desired character key. In this manner, the student is provided with both audible and visual hints and clues as an audiovisual show generally suggestive of which character key 22 they should press.

The sounds of letters can include one, the other or both of the name of the letter and the sound made by the letter when the letter is pronounced.

A first test 54 checks to see if a character key 22 has been pressed, and if it has, a second test 56 checks to see if it was the correct character key 22 corresponding to the sounds and images provided. If the second test 56 finds that the correct character key 22 has been pressed, a second operation 58 causes one, the other or both of the speakers 20 and the display 16 to provide a “praise show” indicating to the student that they have pressed the correct character key 22 with the indicated key top sticker 26 attached thereto.

A third operation 60 then causes the application program 30 to select the next character key 22 with its associated key top sticker 26 that the student should next press. Selection of the next character can include reference to the modification portion 40 of the application program 30 to select a next character in keeping with the student's performance to date. In addition, the selection portion 38 of the application program 30 is included in the process of selecting the next character. As stated above, the selection portion can include lists of characters to be selected and/or a pseudorandom generation process to the next character.

The third operation 60 passes control back to the first operation 52 to display the next selected character audiovisual cue.

If the second test 56 finds that the student has not pressed correct character key 22, a fourth operation 62 causes the speakers 20 and/or the display 16 to present to the student a “please try again” presentation to encourage the student.

The presentations given by the second operation 58 and the fourth operation 62 can comprise one, some or all of, but is not limited to: a spoken commentary; fanfares; negative noises (as often used in television quiz shows); music; cartoon animation; video clips; and one or more static images sequence. The encouragement is tailored to the age and cultural background of the student.

From the fourth operation 62 a third test 64 checks to see if the student has unsuccessfully tried to locate the correct character key 22 more than a predetermined number of times. If the student has not exceeded the maximum number of tries, the third test returns control back to the first operation 52 once again to provide the audiovisual cue for the character key 22 and its associated key top sticker 26.

If the student has exceeded the maximum number of incorrect tries, the third test 64 sends control onward to the third operation 60 to select a new character key 22. As before, the third operation 60 sends control to the first operation 52 to provide the audio visual cue for the newly selected character key 22.

In another alternative to the flow chart shown in FIG. 7, the first operation 52 provides to the student a purely visual presentation, where the display 16 shows one or more graphic images of the animal displayed on the key top sticker 26 together with the appearance of one or more versions of the selected letter.

In yet another alternative for the flow chart shown in FIG. 7, the first operation 52 can provide an appropriate animal animation together with representations of the typed and/or written representations of the desired character key 22.

In any of the examples given above, the character recognition portion 42 of the application program 30 can be employed to interpret characters are written upon the writing tablet 18 to determine whether or not the selected character is the correct character. This feature enables students to improve their proficiency in hand-eye coordination to write the character.

Those skilled in the art will be aware of many variations of the presented cues provided to the student that can also be used as stages in learning the association between individual letters, their sounds, what animal they represent and which key 22 to depress in order to type that letter.

While invention is described with reference to keyboard stickers 26 that bear representations of animals, it is to be appreciated that those skilled in the art will be aware of different types of representation that can equally well be used without providing a bar to a visual-cue non student typists still being able to discern which key they should press.

The invention is more clearly defined by the following claims.

1. A system for keyboard training, comprising:
a keyboard comprising character keys, each character key representing a letter to be typed;
a processor operable to receive typed characters typed upon the character keys of the keyboard;
a display screen operable to display images provided by the processor;
one or more speakers operable to produce sounds provided by the processor;
where
character keys stickers bearing creature representations are placed upon each of their respective character keys;
and where
the processor is operable to select a letter and to provide an audiovisual show through the display screen and/or the speakers to indicate to a student the character key that the students should press.

2. The system of claim 1 wherein the audiovisual show includes at least one of; animal sounds; static animal images; static animal cartoon images; animal video clips; animal cartoon clips; the sounds of the letter to be pressed; the name of the letter; a representation of the letter to be pressed; and a written image of the letter produced by the character key to be pressed.

3. The system of claim 1 wherein the creature representation for each respective character key is in the form of the shape of the letter represented by that character key.

4. The system of claim 1 wherein the processor is operable to determine whether or not a key pressed by the student corresponds to the creature represented by the audiovisual show; and wherein the processor is further operable to tailor the audiovisual show in response to the keyboard activity of the student.

5. The system of claim 1 further comprising a writing tablet operable to provide representation of a character written there on to the processor; the processor being operable to determine whether or not the written character from the writing tablet corresponds to the character represented by the audiovisual show.

6. The system of claim 1 wherein the creature representations are cartoon representations.

7. The system of claim 1 wherein the character keys stickers are provided on a character key sheet and laid out to correspond to the positions on the keyboard whereto they are to be attached.

8. A method for keyboard training, comprising:
a step of a processor receiving typed characters typed upon the character keys of a keyboard comprising character keys, each character key representing a letter to be typed;
a step of displaying upon a display screen images provided by the processor;
a step of producing sounds provided by the processor on one or more speakers;
a step of attaching character keys stickers bearing creature representations upon each of their respective character keys;
and
a step of the processor selecting a letter and providing an audiovisual show through the display screen and/or the speakers to indicate to a student the character key that the students should press.

9. The method of claim 8 wherein the audiovisual show includes at least one of: animal sounds; static animal images; static animal cartoon images; animal video clips; animal cartoon clips; the sounds of the letter to be pressed; the name of the letter; a representation of the letter to be pressed; and a written image of the letter produced by the character key to be pressed.

10. The method of claim 8 wherein the creature representation for each respective character key is in the form of the shape of the letter represented by that character key.

11. The method of claim 8 including the steps of:
a step of the processor determining whether or not a key pressed by the student corresponds to the creature represented by the audiovisual show; and
a step of the processor tailoring the audiovisual show in response to the keyboard activity of the student.

12. The method of claim 8 further comprising the steps of:
the processor receiving from a writing tablet a representation of a character written thereon; and
the processor determining whether or not the written character from the writing tablet corresponds to the character represented by the audiovisual show.

13. The method of claim 8 wherein the creature representations are cartoon representations.

14. The method of claim 8 further comprising the steps of;
providing the character keys stickers on a character key sheet; and
laying out the character key stickers to correspond to the positions on the keyboard whereto the respective character key stickers are to be attached.
